(19) United States
(12) Patent Application Publication
(10) Pub. No.: US 2021/0312430 A1
(43) Pub. Date: Oct. 7, 2021

(54) WALLET SERVER, WALLET PROGRAM, AND WALLET SYSTEM

(71) Applicant: TOYOTA JIDOSHA KABUSHIKI KAISHA, Toyota-shi (JP)

(72) Inventors: Yurika TANAKA, Yokosuka-shi (JP); Hideo HASEGAWA, Nagoya-shi (JP); Nozomu YOSHIOKA, Kasugai-shi (JP); Tsuyoshi TAKESHITA, Nagoya-shi (JP); Shoichiro SUZUKI, Tokyo (JP); Kohei ICHIHARA, Machida-shi (JP); Shota YAMAMOTO, Tokyo (JP); Junya CHIKANISHI, Tokyo (JP)

(73) Assignee: TOYOTA JIDOSHA KABUSHIKI KAISHA, Toyota-shi (JP)

(21) Appl. No.: 17/171,233

(22) Filed: Feb. 9, 2021

(30) Foreign Application Priority Data
Apr. 2, 2020 (JP) 2020-066445

(51) Int. Cl. G06Q 20/36; G06Q 20/06

(52) U.S. Cl. CPC G06Q 20/3674; G06Q 20/065

(57) ABSTRACT

A wallet server includes a processor having hardware. The processor is configured to acquire additional information including content to be provided to a user from a plurality of settlement service provider servers configured to provide a plurality of different settlement methods, acquire user information regarding the user from a user terminal carried by the user, select at least one settlement method among the plurality of different settlement methods based on at least one kind of information of the additional information and the user information, and transmit the at least one selected settlement method to the user terminal.

### CROSS-REFERENCE TO RELATED APPLICATION

This application claims priority to Japanese Patent Application No. 2020-066445 filed on Apr. 2, 2020, incorporated herein by reference in its entirety.

### BACKGROUND

### 1. Technical Field

The present disclosure relates to a wallet server, a wallet program, and a wallet system.

### 2. Description of Related Art

Japanese Unexamined Patent Application Publication No. 2019-087081 (JP 2019-087081 A) discloses a technique that acquires positional information of a user using a portable terminal, when a plurality of available mediums is specified based on the positional information, specifies a settlement method for use in settlement based on statuses of use of the available mediums, and executes settlement request processing to a bank server.

### SUMMARY

There is demand for a reduction in complication in a wallet system in which a plurality of settlement methods is available.

The present disclosure has been accomplished in view of the above description, and provides a wallet server, a wallet program, and a wallet system capable of reducing complication in a wallet system in which a plurality of settlement methods is available.

A first aspect of the present disclosure relates to a wallet server. The wallet server includes a processor having hardware. The processor is configured to acquire additional information including content to be provided to a user from a plurality of settlement service provider servers configured to provide a plurality of different settlement methods, acquire user information regarding the user from a user terminal carried by the user, select at least one settlement method among the plurality of different settlement methods based on at least one kind of information of the additional information and the user information, and transmit the at least one selected settlement method to the user terminal.

A second aspect of the present disclosure relates to a wallet program causing a processor having hardware to execute acquiring additional information including content to be provided to a user from a plurality of settlement service provider servers configured to provide a plurality of different settlement methods, acquiring user information regarding the user from a user terminal carried by the user, selecting at least one settlement method among the plurality of different settlement methods based on at least one kind of information of the additional information and the user information, and displaying the at least one selected settlement method on a display of the user terminal.

A third aspect of the present disclosure relates to a wallet system including a wallet server, a settlement service provider server, and a user terminal. The wallet server includes a first processor having hardware. The settlement service provider server includes a second processor having hardware and is configured to provide a predetermined settlement method. The user terminal includes a third processor having hardware and is carried by a user. The first processor is configured to acquire additional information including content to be provided to the user transmitted from the settlement service provider server, acquire user information regarding the user transmitted from the user terminal, select at least one settlement method among a plurality of different settlement methods to be provided by a plurality of the settlement service provider servers, respectively, based on at least one kind of information of the additional information and the user information, and transmit information regarding the at least one selected settlement method to the user terminal. The third processor is configured to display information regarding the settlement method received from the wallet server on a display of the user terminal.

According to the aspects of the present disclosure, it is possible to reduce complication in a wallet system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a wallet system according to an embodiment;

FIG. 2 is a block diagram showing details of each component of the wallet system according to the embodiment;

FIG. 3 is a diagram schematically showing a relationship of payment means, deposit means, and settlement means in the wallet system according to the embodiment;

FIG. 4 is a diagram schematically showing a relationship between a wallet and a settlement method in the wallet system according to the embodiment;

FIG. 5 is a flowchart showing an example of a method of selecting settlement means that is executed by the wallet system according to the embodiment;

FIG. 6 is a diagram showing an example where a plurality of settlement means is displayed in a list in an operation and display unit of a user terminal in the wallet system according to the embodiment; and

FIG. 7 is a diagram showing an example where a settlement screen including a settlement means display area of “A Pay” is displayed on the operation and display unit of the user terminal in the wallet system according to the embodiment.

### DETAILED DESCRIPTION OF EMBODIMENTS

Hereinafter, an embodiment of the present disclosure will be described referring to the drawings. In all drawings of the embodiment described below, the same or corresponding portions are represented by the same reference signs. The present disclosure is not limited to the embodiment described below. Components in the following embodiment include components that are replaceable and easily constituted by those skilled in the art or substantially identical components.

### Wallet System

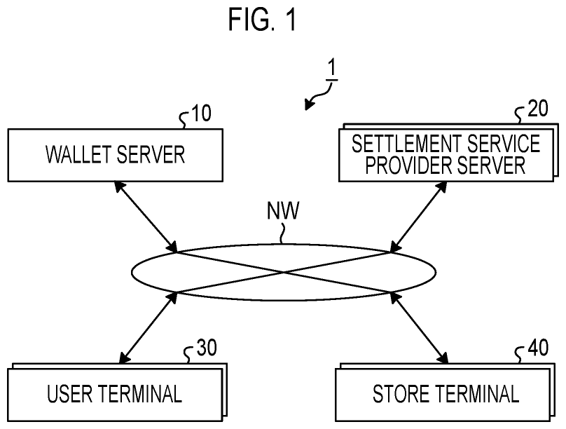

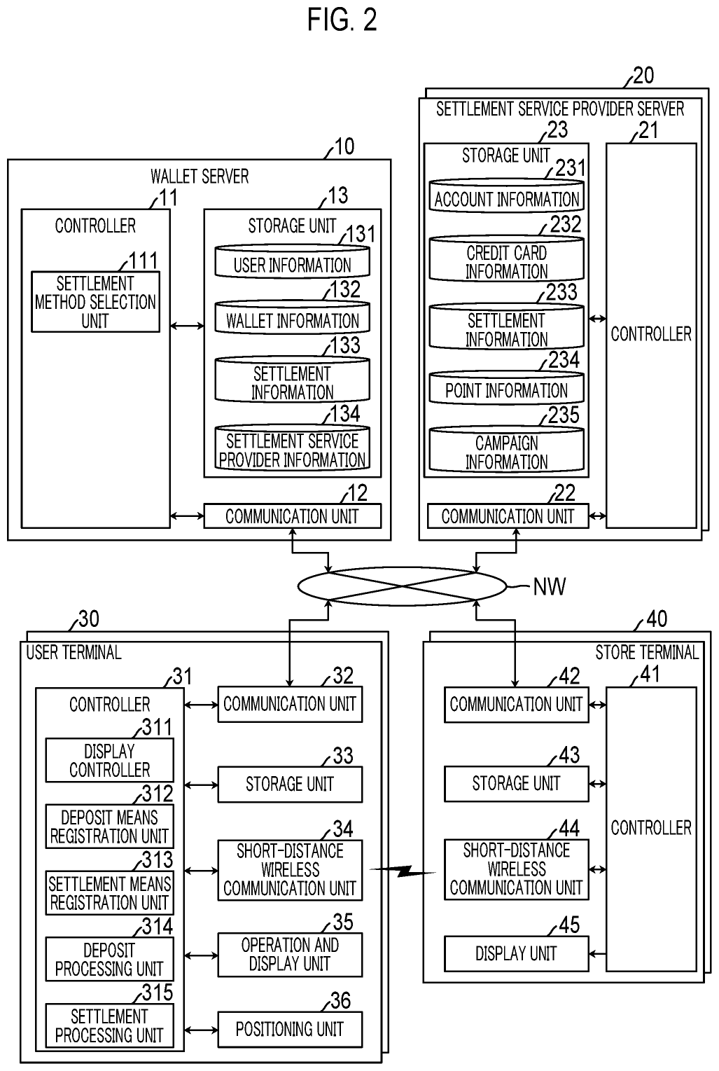

The configuration of a wallet system according to the embodiment will be described referring to FIGS. 1 and 2. As shown in FIG. 1, a wallet system 1 has a wallet server 10, a settlement service provider server 20, a user terminal 30, and a store terminal 40.

The wallet server 10, the settlement service provider server 20, the user terminal 30, and the store terminal 40 are configured to perform communication with one another through a network NW. The network NW is constituted of, for example, an Internet network or a mobile phone network. The network NW may include, for example, other communication networks, such as a wide area network (WAN), a telephone communication network or a mobile phone or the like, and a wireless communication network, such as WiFi (Registered Trademark).

### Wallet Server

The wallet server 10 is a server that integrally manages the wallet system, and is managed by a manager of the wallet system 1. As shown in FIG. 2, the wallet server 10 includes a controller 11 as a first processor, a communication unit 12, and a storage unit 13. The controller 11 includes a settlement method selection unit 111.

The controller 11 as a first processor having hardware specifically includes a processor, such as a central processing unit (CPU), a digital signal processor (DSP), or a field-programmable gate array (FPGA), and a main storage unit, such as a random access memory (RAM) or a read only memory (ROM). The storage unit 13 is constituted of a storage medium selected from an erasable programmable ROM (EPROM), a hard disk drive (HDD), a removable medium, and the like. Examples of the removable medium include disc recording mediums, such as a universal serial bus (USB) memory, a compact disc (CD), a digital versatile disc (DVD), and a Blu-ray disc (BD) (Registered Trademark). In the storage unit 13, an operating system (OS), various programs, various tables, various databases, and the like can be stored.

The controller 11 loads programs stored in the storage unit 13 on a work area of the main storage unit and executes the programs, thereby controlling the components and the like through the execution of the programs. The controller 11 realizes functions conforming to predetermined purposes by controlling the components and the like through the execution of the program. With this, the controller 11 can realize the function of the settlement method selection unit 111 conforming to a predetermined purpose. The settlement method selection unit 111 may include a learned model generated by machine learning. That is, a program may be a learning model or a learned model that can realize the function of the settlement method selection unit 111. Here, the learned model can generate an input-output data set of a predetermined input parameter and a predetermined output parameter as training data by, for example, machine learning, such as deep learning using a neural network. The learned model can be generated by machine learning using, as training data, an input-output data set of user information, settlement service provider information, and campaign information as an input parameter and a settlement method as an output parameter.

The communication unit 12 as an information acquisition unit is constituted of, for example, a local area network (LAN) interface board and a wireless communication circuit for wireless communication. The LAN interface board or the wireless communication circuit in the communication unit 12 is connected to the network NW, such as the Internet as a public communication network. The communication unit 12 is connected to the network NW to perform communication with the settlement service provider server 20, the user terminal 30, and the store terminal 40.

In the storage unit 13 according to the embodiment, user information 131, wallet information 132, settlement information 133, and settlement service provider information 134 for each user of the wallet system are stored.

The user information 131 is information regarding a user who uses the wallet system. Examples of the user information 131 include a user ID of a user who performs use registration of the wallet system, a password, a name of the user, a place to contact of the user (for example, an address, a telephone number, and a mail address), a use registration history, information regarding a registered settlement method, information regarding other settlement methods registered for deposit in the settlement method, and a personal identification number at the time of settlement. The user ID and the password in the user information 131 are used for authentication processing, such as login to the wallet server 10. The user information includes user selection information input by the user using the user terminal 30.

The wallet information 132 is information regarding a wallet of the wallet system. The wallet is an application that manages virtual deposit and withdrawal using various settlement methods, such as a credit card and electronic money. Examples of the wallet information 132 include the user ID, the settlement method, a balance of electronic money, a deposit history of electronic money, and a use history of electronic money.

The settlement information 133 is information regarding settlement of the wallet system. Examples of the settlement information 133 include the user ID, settlement means (for example, electronic money payment (noncontact settlement), scan payment, or code payment) used in settlement, and a settlement history.

The settlement service provider information 134 includes additional information, such as campaign information or point information, to be supplied from the settlement service provider server 20. The additional information includes the campaign information or the point information to be provided to the user with respect to settlement using the user terminal 30 associated with the user information 131. The additional information includes information regarding a return rate to a settlement amount by the settlement method using the user terminal 30.

### Settlement Service Provider Server

The settlement service provider server 20 is a server that manages an account or a credit card of the user. The settlement service provider server 20 is provided in a banking institution, such as a bank, a credit union, a credit association, or a labor credit association, or a credit card company. The settlement service provider server 20 includes a controller 21 as a second processor having hardware, a communication unit 22, and a storage unit 23. The controller 21, the communication unit 22, and the storage unit 23 are functionally the same as the controller 11, the communication unit 12, and the storage unit 13, respectively.

In the storage unit 23, account information 231, credit card information 232, settlement information 233, and point information 234 for each user of the wallet system 1 are stored. Examples of the account information 231 include the name of the user, an account number, an account balance, and a deposit and withdrawal history. Examples of the credit card information 232 include the name of the user, a credit card number, an expiration date of a credit card, a use limit amount, and a card use history. Examples of the settlement information 233 include the user ID, settlement means, and a settlement history. Examples of the point information 234 include the name or unique user ID of the user and the number of points associated with the account information or the credit card information. In the storage unit 23, campaign information 235 that is information regarding a return of points or various campaigns to be held by the settlement service provider is further stored. Examples of the campaign information 235 include information regarding a return rate of points when a predetermined settlement method is used, information regarding an area where a campaign is conducted, and information regarding a coupon to be provided to the user.

### User Terminal

The user terminal 30 as a terminal constituting an information communication unit is a computer terminal that is operated by the user. Examples of the user terminal 30 include a smartphone, a mobile phone, a tablet terminal, a wearable computer, or a personal computer, a car navigation device mounted in a vehicle, and the like that is owned by the user. The user terminal 30 may be any terminal as long as the terminal can exchange information with the wallet server 10.

The user terminal 30 includes a controller 31, a communication unit 32, a storage unit 33, a short-distance wireless communication unit 34, an operation and display unit 35, and a positioning unit 36. The controller 31 as a third processor having hardware, the communication unit 32, and the storage unit 33 are functionally the same as the controller 11, the communication unit 12, and the storage unit 13, respectively. The controller 31 functions as a display controller 311, a deposit means registration unit 312, a settlement means registration unit 313, a deposit processing unit 314, and a settlement processing unit 315 through the execution of the programs.

The display controller 311 controls display contents on the operation and display unit 35 including a display. The display controller 311 displays, on the operation and display unit 35, a member registration screen when the user performs member registration, a login screen when the user logs in to the wallet system, a deposit screen when the user deposits electronic money in the wallet, a settlement screen 35a when settlement is performed, and the like based on a user's operation, such as a touch operation or a flick operation of the user. The display controller 311 transits each screen based on a user's operation. Details of the settlement screen 35a, a purchase amount input screen 35b, and the like will be described below.

The deposit means registration unit 312 registers deposit means for depositing electronic money. The deposit means registration unit 312 transmits a deposit means registration request for registering a plurality of different settlement methods to be operated by a plurality of service providers as deposit means of electronic money to the wallet server 10. Specifically, a plurality of different settlement methods to be operated by a plurality of service providers is, for example, a bank account and a credit card. The controller 11 of the wallet server 10 that receives the deposit means registration request from the deposit means registration unit 312 stores the settlement method included in the deposit means registration request as the user information 131 in the storage unit 13 and registers the settlement method as deposit means.

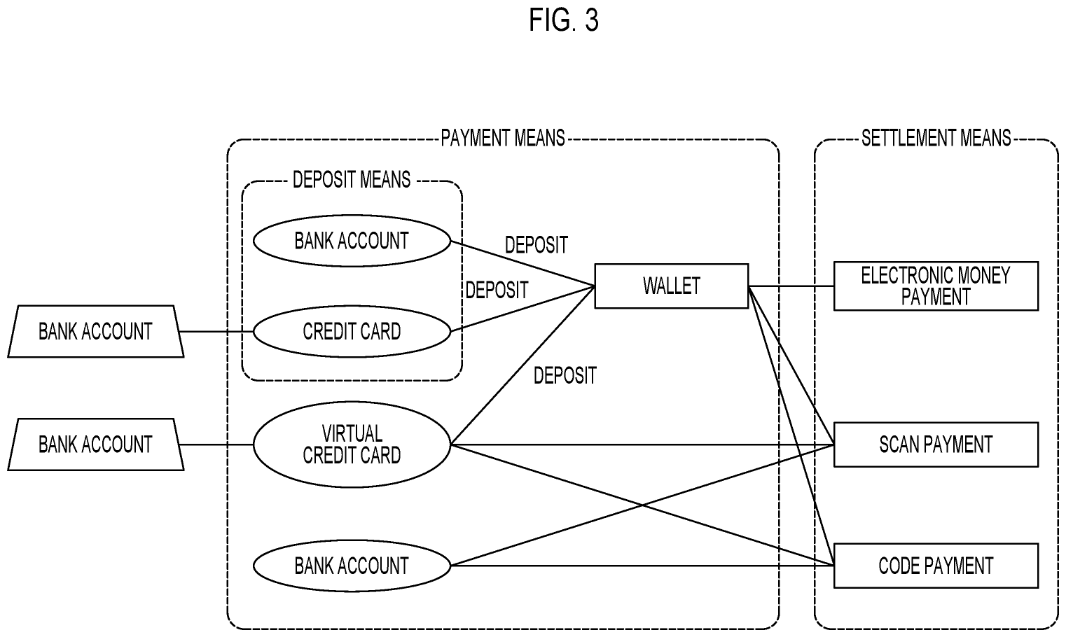

FIG. 3 is a diagram schematically showing a relationship of payment means, deposit means, and settlement means in the wallet system according to the embodiment. The “payment means” indicates means to be a payment resource (funding source) when settlement is performed. As the payment means, a bank account, a credit card, a virtual credit card, and a balance of electronic money in a wallet are included. The virtual credit card is an intangible credit card, and is constituted of, for example, information regarding a card number, an expiration date, and an authentication number (security code). A bank account is associated with each of the credit card and the virtual credit card, and a used amount of each card is withdrawn from the bank account later.

The “deposit means” indicates means for depositing electronic money in a wallet that is a virtual deposit and withdrawal account. As the deposit means, a bank account, a credit card, and a virtual credit card among the payment means are included. The bank account, the credit card, and the virtual credit card are registered as deposit means, whereby it is possible to deposit electronic money in the wallet.

The “settlement means” indicates a method that performs settlement using the payment means. Examples of the settlement means include electronic money payment, scan payment, and code payment. The electronic money payment is settlement that is performed in a noncontact manner between the short-distance wireless communication unit 34 of the user terminal 30 and a short-distance wireless communication unit 44 of the store terminal 40 by the user holding the user terminal 30 up to the store terminal 40. The scan payment is settlement that is performed by reading a barcode or a QR code (Registered Trademark) displayed on the store terminal 40 with a camera or the like of the user terminal 30. The code payment is settlement that is performed by reading a barcode or a QR code (Registered Trademark) displayed on the user terminal 30 with a code reader or the like of the store terminal 40.

In the wallet system according to the embodiment, it is possible to use all three kinds of settlement means using three kinds of payment means. That is, in the wallet system, it is possible to combine the payment means and the settlement means as (1) to (3) described below.
(1) The electronic money payment, the scan payment, and the code payment using the balance of electronic money in the wallet
(2) The electronic money payment, the scan payment, and the code payment using the virtual credit card
(3) The electronic money payment, the scan payment, and the code payment using the bank account

In this way, in the wallet system according to the embodiment, it is possible to charge the wallet with electronic money through a plurality of payment means and to settle the balance of electronic money charging the wallet through a plurality of settlement means.

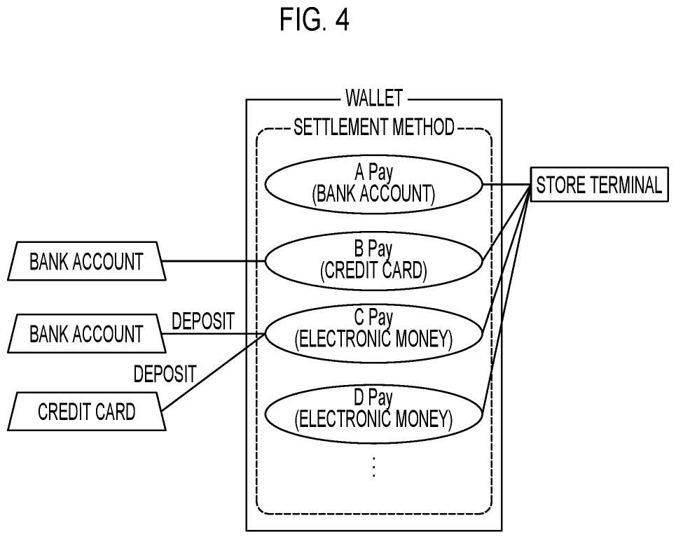

FIG. 4 is a diagram schematically showing a relationship between a wallet and a settlement method in the wallet system 1. The “settlement method” indicates a funding source combining the “payment means” and the “settlement means”. In the wallet, a plurality of settlement methods, such as “A Pay” that is settlement by a bank account, “B Pay” that is settlement by a credit card, and “C Pay” and “D Pay” that are settlement by electronic money, is registered. “A Pay” is a settlement method in which a settlement amount is withdrawn directly from the bank account. A bank account is associated with each credit card (“B Pay”), and a used amount of each card is withdrawn from the bank account later. Deposit means, such as a bank account or a credit card, which is means for performing deposit with electronic money is associated with electronic money (“C Pay”), and enable deposit of electronic money. When electronic money (“D Pay”) is a prepaid type that deposit is performed with cash or the like in advance, deposit means, such as a bank account or a credit card, may not be associated with electronic money. Settlement is performed between the user terminal 30 and the store terminal 40 based on a settlement method selected from among a plurality of settlement methods by the user.

As shown in FIG. 2, the settlement means registration unit 313 registers various kinds of settlement means. The settlement means registration unit 313 transmits a settlement means registration request for registering the settlement means to the wallet server 10. The controller 11 of the wallet server 10 that receives the settlement means registration request from the settlement means registration unit 313 registers, as the settlement means, the settlement method included in the settlement means registration request, by storing the settlement method, as the user information 131, in the storage unit 13. The settlement methods may be registered instead of the settlement means.

The deposit processing unit 314 deposits electronic money in the wallet. Specifically, the deposit processing unit 314 transmits a deposit request for performing deposit with electronic money through the settlement means registered as the deposit means to the wallet server 10. The controller 11 of the wallet server 10 that receives the deposit request from the deposit processing unit 314 increases the balance of electronic money in the wallet based on deposit amount information included in the deposit request. That is, the controller 11 updates the wallet information 132 stored in the storage unit 13 according to an increased amount of the balance of electronic money in the wallet.

The settlement processing unit 315 performs settlement with the settlement method selected by the user. Specifically, the settlement processing unit 315 transmits a settlement request to the store terminal 40 through the short-distance wireless communication unit 34 as the settlement means. Alternatively, the settlement processing unit 315 may transmit the settlement request to the store terminal 40 by reading a barcode or a QR code (Registered Trademark) displayed on the store terminal 40 with the camera or the like of the user terminal 30 as the settlement means. Furthermore, the settlement processing unit 315 may transmit the settlement request to the store terminal 40 by reading a barcode or QR code (Registered Trademark) displayed on the user terminal 30 with the code reader or the like of the store terminal 40 as the settlement means. The settlement request transmitted from the settlement processing unit 315 to the store terminal 40 may include or may not include information (hereinafter, referred to as “settlement amount information”) indicating a settlement amount.

Subsequently, in a case of settlement by the bank account or the credit card, the settlement processing unit 315 transmits the settlement request for performing settlement using any settlement means to the wallet server 10. The controller 11 of the wallet server 10 that receives the settlement request from the settlement processing unit 315 transmits the settlement amount information included in the settlement request to the settlement service provider server 20.

In a case of settlement by electronic money, a controller 41 of the store terminal 40 described below transmits the settlement request including the settlement amount information to the wallet server 10 through the network NW. The controller 11 of the wallet server 10 that receives the settlement request from the store terminal 40 decreases the balance of electronic money in the wallet based on the settlement amount information included in the settlement request. That is, the controller 11 updates the wallet information 132 and the settlement information 133 stored in the storage unit 13 according to a decreased amount of the balance of electronic money in the wallet.

In the storage unit 33, data of various screens that are displayed on the operation and display unit 35 by the display controller 311 is stored. In the storage unit 33, as needed, the user information 131, the wallet information 132, the settlement information 133, and the settlement service provider information 134 or the point information 234 and the campaign information 235 are temporarily stored. The user information stored in the storage unit 33 includes user selection information that is information input by the user using the user terminal 30.

The short-distance wireless communication unit 34 has a communication function, for example, conforming to a standard, such as Near field radio communication (NFC), Bluetooth (Registered Trademark) Low Energy (BLE), or Infrared Data Association (IrDA). For example, when performing settlement by electronic money, the user terminal 30 performs short-distance wireless communication with the store terminal 40 through the short-distance wireless communication unit 34.

The operation and display unit 35 is constituted of, for example, a touch panel display, and has an input function of receiving an operation with a finger of the user or a pen, or the like and a display function of displaying various kinds of information under the control of the display controller 311.

The positioning unit 36 receives radio waves from global positioning system (GPS) satellites to detect positional information of the user terminal 30. The controller 31 transmits the positional information of the user terminal 30 to the wallet server 10, the settlement service provider server 20, or the store terminal 40 through the network NW.

### Store Terminal

The store terminal 40 is provided in, for example, a store (member store) that can use the wallet system. Note that, the store terminal 40 may be a server that functions as a virtual store, so-called an electronic commerce (EC) site, established on the Internet. The store terminal 40 includes the controller 41, a communication unit 42, a storage unit 43, a short-distance wireless communication unit 44, and a display unit 45. The controller 41, the communication unit 42, the storage unit 43, and the short-distance wireless communication unit 44 are functionally the same as the controller 11, the communication unit 12, the storage unit 13, and the short-distance wireless communication unit 34, respectively. The display unit 45 is constituted of, for example, a liquid crystal display (LCD) or an organic EL display (OLED), and displays information under the control of the controller 41.

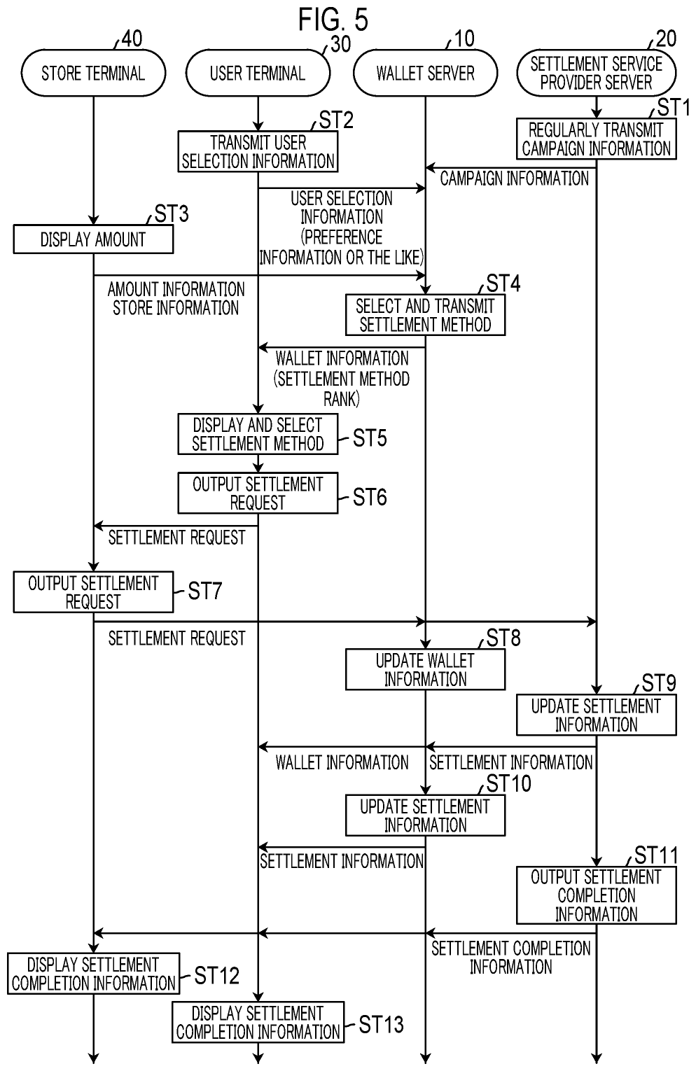

Hereinafter, selection processing of settlement means that is executed in the wallet server 10 in the wallet system 1 including the wallet server 10 according to the embodiment will be described referring to FIGS. 5 to 7. In the following description, transmission and reception of information are performed through the network NW, and description of this point on each occasion will be omitted. When information is transmitted and received among the wallet server 10, each settlement service provider server 20, each user terminal 30, and each store terminal 40, identification information for individually specifying each of the settlement service provider server 20, the user terminal 30, and the store terminal 40 is also transmitted and received in association with information to be transmitted and received, and description of this point on each occasion will also be omitted.

As shown in FIG. 5, first, in Step ST1, the settlement service provider server 20 regularly transmits the campaign information to the wallet server 10. In the wallet server 10, the acquired campaign information is stored as the settlement service provider information 134 in the storage unit 13.

On the other hand, in Step ST2, the user terminal 30 transmits the user selection information input to the user terminal 30 by the user, specifically, for example, preference information indicating the preference of the user or purpose information indicating the purpose of the user to the wallet server 10. The transmission of the user selection information may be suitably performed or may be regularly performed.

On the other hand, the user who enters a store with the store terminal 40 delivers an article to a salesperson or receives provision of a predetermined service from the salesperson. In Step ST3, the salesperson prompts the user for payment of a charge using the store terminal 40. The controller 41 displays an amount on the display unit 45 of the store terminal 40. The store terminal 40 transmits amount information of the charge and store information to the wallet server 10.

Thereafter, in Step ST4, the settlement method selection unit 111 of the controller 11 of the wallet server 10 selects at least one settlement method from among a plurality of settlement methods based on the user information 131, the wallet information 132, and the settlement service provider information 134 stored in the storage unit 13 on the user of the user terminal 30. The user information 131 includes the user selection information of each user. The settlement service provider information 134 includes the point information 234 of each user or the campaign information 235 of each settlement service provider.

That is, the settlement method selection unit 111 may select a settlement method beneficial to the user based on the preference information set by the user in advance, information regarding the kind of point desired by the user, the campaign information, and past purchase information or preference information. For example, when the user selection information input to the user terminal 30 by the user includes, for example, information for the purpose of “purchase of a vehicle”, the settlement method selection unit 111 selects at least one settlement method that easily stores points usable for purchase of a vehicle. Furthermore, for example, when the user selection information includes information for the purpose of “going on a trip abroad”, the settlement method selection unit 111 may select at least one settlement method that easily stores points to be operated by an airline company, such as mileage. In these cases, the settlement method selection unit 111 may select at least one settlement method having a high return rate of points with respect to a settlement amount based on a return rate of points included in the settlement service provider information 134. The settlement method selection unit 111 may further select another settlement method that easily stores points. In this case, the settlement method selection unit 111 ranks at least two settlement methods including another settlement method in an order of determination to be beneficial.

When the user selection information includes points to be operated by a predetermined settlement service provider, for example, information for the purpose of “A points are intensively stored”, the settlement method selection unit 111 selects at least one settlement method that easily stores points of a service (hereinafter, referred to as an A point service) for providing A points. Furthermore, there is a case where a purchase amount on an EC site established by the settlement service provider, which operates the A point service, in purchase information included in the user information is greater than a purchase amount on another EC site, for example, an EC site established by a settlement service provider, which operates a B point service. Even in this case, the settlement method selection unit 111 selects at least one settlement method that easily stores points of the A point service. Alternatively, the settlement method selection unit 111 may select a settlement method, which easily stores points of the B point service, as a settlement method in a next order. That is, the settlement method selection unit 111 may perform ranking such that the settlement method that easily stores A points is ranked in a first rank and the settlement method that easily stores B points is ranked in a second rank.

When the user selection information does not include information regarding the purpose of the user, or the like, the settlement method selection unit 111 may select a settlement method such that a substantial amount of payment, in other words, a value obtained by subtracting points from an amount of payment of charge is minimized. In addition, there is a case where a coupon, a higher return rate of points, or the like obtained solely when the user terminal 30 is positioned within a predetermined area is set based on a current position of the user terminal 30 acquired by the positioning unit 36 of the user terminal 30. Even in this case, the settlement method selection unit 111 may select a settlement method such that the substantial amount of payment is minimized according to the return rate of points or the presence or absence of the coupon based on the positional information of the user terminal 30.

With the above, the settlement method selection unit 111 can select at least one beneficial settlement method according to a request of each user, and in a case where a plurality of settlement methods is selected, can rank the settlement methods. The settlement method selection unit 111 transmits information regarding the at least one selected settlement method and information regarding the rank of the settlement method to the user terminal 30.

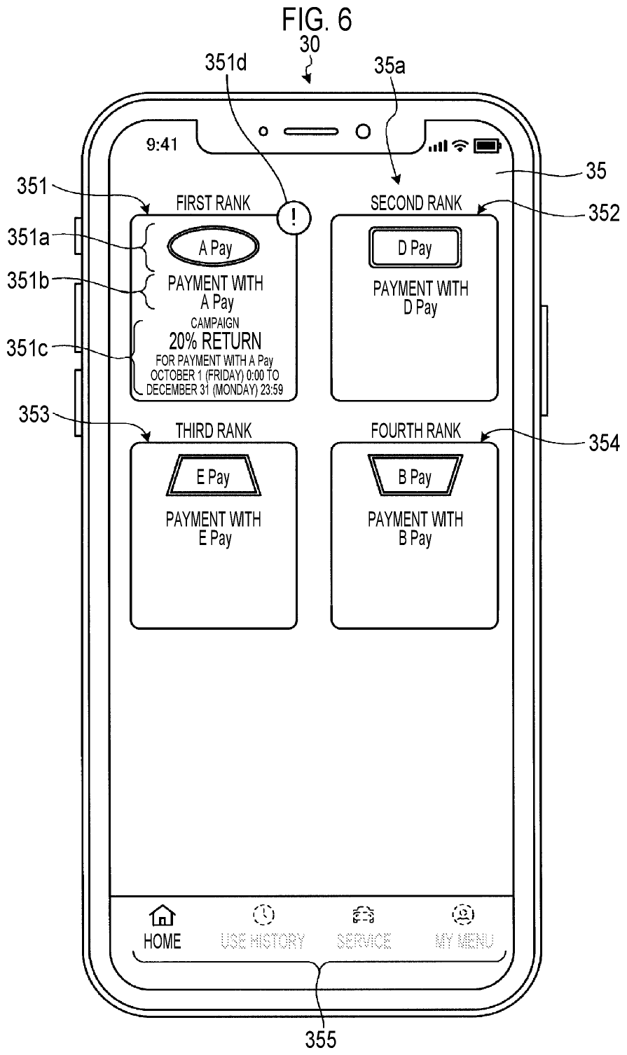

In Step ST5, the display controller 311 of the user terminal 30 displays the received settlement methods on the operation and display unit 35 based on the received information regarding the rank. FIG. 6 shows an example of a settlement screen 35a that is displayed on the operation and display unit 35 by the display controller 311. The settlement screen 35a is a screen that receives the settlement methods from the wallet server 10 and is displayed, for example, when the application of the wallet is opened in the user terminal 30. In the example shown in FIG. 6, the settlement screen 35a when “A Pay”, “B Pay”, “D Pay”, and “E Pay” are registered as the settlement method is shown.

Specifically, the settlement screen 35a includes settlement icons 351, 352, 353, and 354 displayed in a list, and a menu switching area 355. The settlement icons 351 to 354 are areas that display the settlement methods, and receive requests for performing settlement using the displayed settlement methods. When the settlement method selection unit 111 ranks “A Pay” in a first rank, ranks “B Pay” in a fourth rank, ranks “D Pay” in a second rank, and ranks “E Pay” in a third rank, the settlement icons 351 to 354 are displayed in a list in an order of the rank on the settlement screen 35a along with the rank.

The display controller 311 displays a settlement name 351a, a settlement phrase 351b, a settlement information area 351c, and a notification icon 351d, for example, in the settlement icon 351. The settlement name 351a indicates a name of a settlement method usable in the user terminal 30. The settlement phrase 351b specifies the effect that settlement by the settlement method is performed. The settlement information area 351c displays additional information regarding each settlement method. The notification icon 351d means that there is additional information for notifying of campaign information or the like. A display method of the contents is just an example, and various display methods can be employed.

Specifically, in the settlement icon 351, a mark including the name “A Pay” as the settlement name 351a, that is, a logo mark, an acceptance mark, or the like is displayed. As the settlement phrase 351b, for example, characters “Payment with A Pay” are displayed. As the settlement information area 351c, for example, information regarding a campaign as a service regarding “A Pay” is displayed. In addition, the notification icon 351d for making the user recognize the campaign is displayed. Even in the settlement icons 352 to 354, the name of the settlement method, the mark indicating the settlement method, the settlement phrase, the additional information, the icon, and the like are displayed, and are functionally the same as the settlement icon 351.

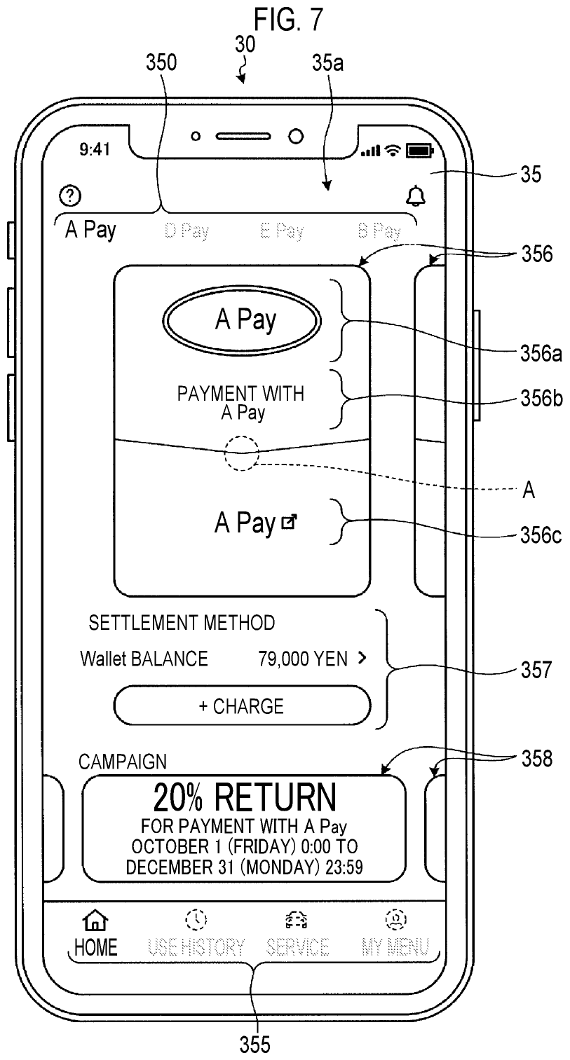

Here, in FIG. 6, when the settlement icon 351 indicating “A Pay” is selected by the user, the display controller 311 displays an electronic settlement screen prepared in advance. Specifically, the display controller 311 displays a screen on which a message for prompting settlement to be performed in a noncontact manner between the short-distance wireless communication unit 34 and the short-distance wireless communication unit 44 is displayed, a screen for scan payment prepared in advance, a screen for code payment prepared in advance, or the like. FIG. 7 shows a settlement screen 35a of a virtual settlement method, called “A Pay”, in which electronic money payment is set as a settlement method. On the settlement screen 35a, specifically, a settlement means switching area 350, a settlement means display area 356, a payment means area 357, an additional information area 358, and the menu switching area 355 are included.

The settlement means switching area 350 is an area for switching settlement means. For example, when any one of the names “A Pay”, “D Pay”, “E Pay”, and “B Pay” of the settlement methods in the settlement means switching area 350 is selected based on a touch operation of the user on the operation and display unit 35, the display controller 311 displays the settlement screen 35a corresponding to the selected settlement method. In the example shown in FIG. 7, four kinds of settlement methods shown in FIG. 6 are arranged and displayed in an order of the rank. With this, it is possible to allow the user to intuitively ascertain a settlement method of which the use is beneficial to the user.

The display controller 311 actively displays the name of the settlement means in a selected state in the settlement means switching area 350. “Active display” means highlighting such that the characters more attract attention than other characters by magnifying a font, changing the font, changing a font color, inverting a background color (highlighting), or the like.

For example, in the settlement means switching area 350 of FIG. 7, “A Pay” in a selected state is actively displayed, and other “D Pay”, “E Pay”, and “B Pay” are displayed thin (hereinafter, referred to as inactive display) not to attract attention. In the wallet system 1 according to the embodiment, the name of the settlement method in the selected state is actively displayed, whereby it is possible to allow the user to intuitively ascertain a settlement method that is used by the user.

The settlement means display area 356 is an area where settlement means is displayed. The display controller 311 displays, in the settlement means display area 356, a settlement name 356a indicating the name of settlement means usable in the user terminal 30, a settlement phrase 356b for specifying the effect that settlement by the settlement means is performed, and a settlement button 356c for issuing a settlement request by the settlement means. Other types of display may be performed or a part of display may be brought into non-display. For example, in FIG. 7, a logo mark (acceptance mark) of “A Pay” is displayed as the settlement name 356a, characters “Payment with A Pay” are displayed as the settlement phrase 356b, and an electronic settlement mark of “A Pay” is displayed as the settlement button 356c. In FIG. 7, when the electronic settlement mark of “A Pay” is selected by the user, the display controller 311 may display an electronic settlement screen prepared in advance.

The display controller 311 arranges and displays the settlement name 356a and the settlement button 356c up and down in the settlement means display area 356. For example, as shown in FIG. 7, the display controller 311 arranges and displays the settlement name 356a, the settlement phrase 356b, and the settlement button 356c in order from above. As shown in an A portion of the drawing, the display controller 311 displays a borderline having a corner portion formed by two inclined surfaces inclined downward between the settlement phrase 356b and the settlement button 356c. In the wallet system 1 according to the embodiment, the settlement name 356a and the settlement button 356c are arranged and displayed up and down, and the borderline having the corner portion is displayed, whereby it is possible to make a point of view of the user naturally transit among the settlement name 356a, the settlement phrase 356b, and the settlement button 356c in this order. Accordingly, since the user does not hesitate to perform an operation, whereby convenience is improved at the time of settlement. The display controller 311 may display the balance of electronic money on the settlement icon in a superimposed manner. As a result, the user easily recognizes the balance of electronic money, and convenience is improved.

The menu switching area 355 is an area for switching menu items. In the example shown in FIGS. 4 to 7, HOME, USE HISTORY, SERVICE, and MY MENU are provided as the menu items. “HOME” is a menu item that is provided to display the settlement screen 35a. “USE HISTORY” is a menu item that is provided to display a use history screen. “SERVICE” is a menu item that is provided to display a page regarding, for example, a service, such as a rent-a-car service, which can use the wallet system according to the embodiment. “MY MENU” is a menu item that is provided to display a page for inquiry, change, and the like of the user information 131.

Alternatively, the display controller 311 may display the settlement methods in an order in which the settlement methods are used (a settlement method used latest is displayed with priority), in an order in which information, such as campaign information, is updated (a settlement method of which information is updated latest is displayed with priority), or in an order in which a campaign ends.

Returning to FIG. 5, in Step ST6, the settlement processing unit 315 of the user terminal 30 outputs the settlement request for settling the settlement amount decided in Step ST3 with electronic money charging the wallet to the store terminal 40. Subsequently, in Step ST7, the controller 41 outputs the settlement request acquired from the user terminal 30 to the wallet server 10 and the settlement service provider server 20. The settlement request may be transmitted to solely one of the wallet server 10 and the settlement service provider server 20.

In Step ST8, the controller 11 of the wallet server 10 updates the wallet information 132 stored in the storage unit 13 based on the wallet information 132 selected in Step ST5. The controller 11 transmits the updated wallet information 132 to the user terminal 30. On the other hand, in Step ST9, the controller 21 of the settlement service provider server 20 updates the settlement information 233 stored in the storage unit 23 in the settlement amount. The settlement service provider server 20 transmits the updated settlement information 233 to the wallet server 10. In Step ST10, the controller 11 of the wallet server 10 updates the settlement information 133 with the received settlement information 233. The controller 11 transmits the updated settlement information 133 to the user terminal 30. Subsequently, in Step ST11, the controller 21 of the settlement service provider server 20 transmits settlement completion information including content of completion of settlement processing to the wallet server 10, the user terminal 30, and the store terminal 40. All Steps ST8 to ST11 may be executed by the controller 11 of the wallet server 10. All Steps ST8 to ST11 may be executed by the controller 21 of the settlement service provider server 20.

Thereafter, in Step ST12, the controller 41 of the store terminal 40 displays the settlement completion information on the display unit 45. On the other hand, the controller 31 of the user terminal 30 displays the settlement completion information on the operation and display unit 35. With the above, the settlement processing in the wallet system 1 including the selection processing of the settlement method according to the embodiment ends.

As described above, according to the embodiment, since an optimum settlement method can be selected from among a plurality of settlement methods in the wallet system that can use a plurality of settlement methods, it is possible to reduce complication in selecting a settlement method, and to improve convenience for the user.

Although the embodiment of the present disclosure has been specifically described above, the present disclosure is not limited to the above-described embodiment, various modifications based on the technical idea of the present disclosure and an embodiment combining the respective embodiments can also be made. For example, information or the display screen exemplified in the above-described embodiment is just an example, and different kinds of information or display screens may be used as needed.

For example, the wallet system including the wallet server according to the embodiment can be used in electronic commerce on the Internet in addition to face-to-face settlement in a real store, such as electronic money payment, scan payment, and code payment.

When the user terminal 30 is a car navigation device that is mounted in a vehicle, the wallet system including the wallet server according to the embodiment can be used in settlement that is performed during driving of the vehicle.

For example, in the embodiment, although deep learning using a neural network has been exemplified as an example of machine learning, machine learning based on other methods may be performed. For example, other supervised learning, such as support vector machines, decision trees, simple Bayes, or k-nearest neighbors, may be used. Semi-supervised learning may be used instead of supervised learning. In addition, reinforcement learning or deep reinforcement learning may be used as machine learning.

### Recording Medium

In the above-described embodiment, a program that can execute a processing method by the controller 11 of the wallet server 10 or the controller 31 of the user terminal 30 can be recorded on a recording medium that is readable by a computer or other machines or apparatuses (hereinafter, referred to as a computer or the like). The program on the recording medium is read to and executed on the computer or the like, whereby the computer or the like functions as the controller of the wallet server 10 or the user terminal 30. Here, the recording medium that is readable by the computer or the like refers to a non-transitory recording medium on which information, such as data or programs, can be accumulated by an electrical, magnetic, optical, mechanical, or chemical action and can be read through the computer or the like. Among such recording mediums, examples of recording mediums that are removable from the computer or the like include a flexible disk, a magneto-optical disk, a CD-ROM, a CD-R/W, a digital versatile disk (DVD), a BD, a DAT, a magnetic tape, and a memory card, such as a flash memory. Examples of recording mediums that are fixed in the computer or the like include a hard disk and a ROM. In addition, an SSD is available as a recording medium that is removable from the computer or the like or as a recording medium that is fixed in the computer or the like.

### Other Embodiments

In the wallet server 10, the settlement service provider server 20, the user terminal 30, and the store terminal 40 according to the embodiment, the “unit” described above can be replaced with a “circuit” or the like. For example, the controller can be replaced with a control circuit.

The program that is executed by the controller 11 of the wallet server 10 or the controller 31 of the user terminal 30 according to the embodiment may be provided by storing the program on a computer connected to a network, such as the Internet, and downloading the program by way of the network.

In the description of the flowchart in the specification, although an anteroposterior relationship of processing between the steps is clarified using the expressions “first”, “thereafter”, “subsequently”, and the like, the order of the processing needed to carry out the embodiment shall not be defined uniquely by the expressions. That is, the order of the processing in the flowchart described in the specification can be changed without contradiction.

Other effects or modification examples can be easily derived by those skilled in the art. Broader aspects of the present disclosure are not limited to specific details and representative embodiments shown and described above. Accordingly, various alterations may be made without departing from the spirit or scope of the general inventive concept defined by the appended claims and equivalent thereof.

What is claimed is:

1. A wallet server comprising a processor having hardware,
wherein the processor is configured to
acquire additional information including content to be provided to a user from a plurality of settlement service provider servers configured to provide a plurality of different settlement methods,
acquire user information regarding the user from a user terminal carried by the user,
select at least one settlement method among the plurality of different settlement methods based on at least one kind of information of the additional information and the user information, and
transmit the at least one selected settlement method to the user terminal.

2. The wallet server according to claim 1, wherein at least two settlement methods among the plurality of different settlement methods are ranked based on at least one kind of information of the additional information and the user information, and information regarding the at least two ranked settlement methods is transmitted to the terminal.

3. The wallet server according to claim 1, wherein the processor is configured to select at least one settlement method among the plurality of different settlement methods based on the additional information and the user information.

4. The wallet server according to claim 1, wherein the user information includes user selection information input to the user terminal by the user.

5. The wallet server according to claim 1, wherein the user information includes purchase information of a use history of a settlement method used in settlement by the user.

6. The wallet server according to claim 1, wherein the additional information includes campaign information or point information to be provided to the user with respect to settlement using the user terminal.

7. The wallet server according to claim 1, wherein the additional information includes information regarding a return rate to a settlement amount by the settlement method using the user terminal.

8. A wallet program causing a processor having hardware to execute
acquiring additional information including content to be provided to a user from a plurality of settlement service provider servers configured to provide a plurality of different settlement methods,
acquiring user information regarding the user from a user terminal carried by the user,
selecting at least one settlement method among the plurality of different settlement methods based on at least one kind of information of the additional information and the user information, and
displaying the at least one selected settlement method on a display of the user terminal.

9. The wallet program according to claim 8, wherein at least two settlement methods among the plurality of different settlement methods are ranked based on at least one kind of information of the additional information and the user information, and information regarding the at least two ranked settlement methods is transmitted to the terminal and displayed on the display.

10. The wallet program according to claim 8, wherein the processor is configured to select at least one settlement method among the plurality of different settlement methods based on the additional information and the user information.

11. The wallet program according to claim 8, wherein the user information includes user selection information input to the user terminal by the user.

12. The wallet program according to claim 8, wherein the user information includes purchase information of a use history of a settlement method used in settlement by the user.

13. The wallet program according to claim 8, wherein the additional information is campaign information or point information to be provided to the user with respect to settlement using the user terminal.

14. The wallet program according to claim 8, wherein the additional information includes information regarding a return rate to a settlement amount by the settlement method using the user terminal.

15. A wallet system comprising:
a wallet server including a first processor having hardware;
a settlement service provider server including a second processor having hardware, the settlement service provider server being configured to provide a predetermined settlement method; and
a user terminal including a third processor having hardware, the user terminal being carried by a user, wherein:
the first processor is configured to
acquire additional information including content to be provided to the user transmitted from the settlement service provider server,
acquire user information regarding the user transmitted from the user terminal,
select at least one settlement method among a plurality of different settlement methods to be provided by a plurality of the settlement service provider servers, respectively, based on at least one kind of information of the additional information and the user information, and
transmit information regarding the at least one selected settlement method to the user terminal; and
the third processor is configured to display the information regarding the settlement method received from the wallet server on a display of the user terminal.

16. The wallet system according to claim 15, wherein:
the first processor is configured to rank at least two settlement methods among the plurality of different settlement methods based on at least one kind of information of the additional information and the user information and transmit information regarding the at least two ranked settlement methods to the user terminal; and
the third processor is configured to display the information regarding the at least two ranked settlement methods received from the wallet server on the display.

17. The wallet system according to claim 15, wherein the first processor is configured to select at least one settlement method among the plurality of different settlement methods based on the additional information and the user information.

18. The wallet system according to claim 15, wherein the user information includes user selection information input to the user terminal by the user.

19. The wallet system according to claim 15, wherein the user information includes purchase information of a use history of a settlement method used in settlement by the user.

20. The wallet system according to claim 15, wherein the additional information includes campaign information or point information to be provided to the user with respect to settlement using the user terminal.
